(19) United States
(12) Patent Application Publication
(10) Pub. No.: US 2017/0284466 A1
(43) Pub. Date: Oct. 5, 2017

(54) PLAIN BEARING OR PART THEREOF, METHOD FOR PRODUCING SAME AND USE OF A CUCRZR ALLOY AS A PLAIN BEARING MATERIAL

(71) Applicant: FEDERAL-MOGUL WIESBADEN GMBH, WIESBADEN (DE)

(72) Inventors: HOLGER SCHMITT, PFUNGSTADT (DE); DANIEL MEISTER, MAINZ-KOSTHEIM (DE)

(21) Appl. No.: 15/508,239

(22) PCT Filed: Aug. 27, 2015
(86) PCT No.: PCT/EP2015/069636

§ 371 Date: Mar. 2, 2017

(30) Foreign Application Priority Data
Sep. 3, 2014 (DE) 102014217570.4

(51) Int. Cl. F16C 33/12; C22C 9/00; B22F 3/24; C22F 1/08; F16C 33/10; F16C 33/14

(52) U.S. Cl. CPC F16C 33/121; F16C 33/1095; F16C 33/14; B22F 3/24; C22F 1/08; C22C 9/00; F16C 2204/10; F16C 2220/44; F16C 2220/02; F16C 2220/20; F16C 2223/30; F16C 2223/70; F16C 2223/10; B22F 2003/248

(57) ABSTRACT

The present application relates to a plain bearing, or a part thereof and to a method for producing same, characterised in that the plain bearing at least partially consists of a CuCrZr alloy. The application also relates to the use of the CuCrZr alloy as a plain bearing material.

### TECHNICAL FIELD

The present invention relates to a plain bearing or a part thereof, such as for example a plain bearing half or plain bearing bushing, reference being made below for simplicity only to a plain bearing, and to a method for producing same, and also to the use of a CuCrZr alloy as a plain bearing material. Such a plain bearing is distinguished by high thermal conductivity and good mechanical properties, corrosion resistance and also workability.

### PRIOR ART

The use of copper-based alloys as a plain bearing material is known from the prior art.

For example, GB 2 281 078 A discloses the use of a sintered compact as bearing surface, the sintered compact consisting of a copper-based alloy, 5 to 20% by weight of a transition metal and 0.5 to 10% by weight of a semimetal. In addition, preferably 0.1 to 0.8% by weight of at least one metal from the group Zr, Mo, Nb and Al is a constituent of the alloy.

Furthermore, copper/chromium/zirconium alloys may be counted among the prior art.

A copper/chromium/zirconium alloy with 0.5 to 1.2% by weight chromium, 0.03 to 0.3% by weight zirconium and remainder copper is listed for example under the material number CW106C. It can be inferred from the corresponding material data sheet of the German Copper Institute (DKI) that this alloy is used in electrical engineering and in mechanical engineering as a contact material and as current-carrying springs, in welding and soldering (electrodes, electrode holders and electrode shafts, nozzles) and also in equipment manufacture.

US 2006/0086437 A1 discloses a method for producing a copper/chromium/zirconium alloy with 0.1 to 1.5% by weight chromium, 0.01 to 0.25% by weight zirconium and remainder copper, the method comprising the steps continuous casting, drawing and precipitation hardening.

### PRESENTATION OF THE INVENTION

It is an object of the invention to make available a plain bearing which has a long life.

This object is achieved by the plain bearing described in claim 1, the method for producing the plain bearing according to claim 8 and the use of a CuCrZr alloy as a plain bearing material according to claim 23.

The at least partial use of a CuCrZr alloy as material for a plain bearing in this case considerably increases the durability of the plain bearing according to the invention.

Thus, owing to the high thermal conductivity of the CuCrZr alloy of 320 W/(mK) at 200° C. both rapid dissipation of heat of friction and homogeneous heat distribution within the material are produced, which ensures a temperature-stable microstructure. In addition, CrZr₃ compounds, which increase the wear resistance of the plain bearing, form in the CuCrZr alloy. Finally, the alloy composition according to the invention has a high corrosion resistance. Initial investigations show that advantageously no costly modifications to existing production installations are necessary for the processing of the material according to the invention. Preferably the CuCrZr alloy consists of 0.01 to 0.5% by weight Zr, 0.11 to 4.9% by weight Cr, optionally up to 15.0% by weight Sn, optionally 0.05 to 0.25% by weight Al, Mg, Ti and/or Mn, and copper as remainder.

Preferred developments are described in the further claims.

Thus, concentration ranges of 0.01 to 0.5% by weight Zr and 0.01 to 4.9% by weight Cr, preferably up to 4.4% by weight Cr, have proved advantageous for the elements chromium and zirconium. In this concentration range, sufficient CrZr₃ compounds are formed and the corrosion resistance is sufficiently increased, without the thermal conductivity of the copper base matrix being significantly reduced.

Advantageously, the CuCrZr alloy additionally contains 0.11 to 15.0% by weight Sn, since this makes it possible to increase the strength and hardness of the alloy further, but at higher tin contents the thermal conductivity is reduced too greatly.

Preferably at least one of the elements Al, Mg, Ti and/or Mn is added to the alloy in a concentration range of 0.05 to 0.25% by weight in each case. The elements mentioned advantageously act as corrosion inhibitors and accordingly reduce the susceptibility of the copper matrix to corrosion, in particular if it is ensured that the distribution of the aforementioned elements in the matrix is as homogeneous as possible.

Advantageously, the CuCrZr alloy has a porosity of <0.3 volume percent, which guarantees sufficient strength.

The sliding properties and the machinability of the plain bearing material produced according to the invention can advantageously be improved in that hard particles, such as oxides, carbides, nitrides and phosphides, and/or solid lubricants, such as h-BN and carbon, in particular graphite, are added. Further, at least one of the chip-breaking elements tellurium, bismuth, lead and sulphur may be supplied as what are called chip breakers. Preferred hard particles are for example Al₂O₃, c-BN, MoSi₂, ZrO₂, SiO₂ and all carbides of the corrosion-preventing metals mentioned.

The CuCrZr alloy is advantageously applied to a substrate backing, preferably a steel backing. Such a structure makes it possible to utilise the beneficial properties of the CuCrZr alloy at those positions of the plain bearing at which they are needed, while less-critical points can be manufactured from less-expensive material.

Preferably the CuCrZr alloy is processed as a solid material, preferably to form bushings and bearings, since this avoids the weak point of adhesion between the substrate and CuCrZr alloy.

While large layer thicknesses can be produced on the substrate very inexpensively due to the application of the CuCrZr alloy to a substrate backing by means of roll bonding cladding, the chemical and physical properties of the CuCrZr alloy can be set in a very defined manner by means of a galvanic process and/or a sputtering process.

Preferably the CuCrZr alloy is formed by a sintering process, consisting of at least one, preferably two, sintering operations, since this means that advantageously subsequent roiling and/or heat treatment steps for setting the structure can be dispensed with.

Advantageously at least one, preferably each, sintering operation is followed by at least one roll pass, since this reduces the porosity.

It has furthermore turned out that the novel plain bearing material can be processed in existing sintering plants advantageously at sintering temperatures of 950° C. to 1000° C., preferably 950° C. to 980° C.

According to a beneficial configuration according to the invention, the functional additions are introduced via a preceding grinding and/or mixing process, so that a homogeneous distribution of the additions is ensured.

The sintering powder is advantageously produced by an atomisation process, preferably atomisation of pure elements. Particularly preferably, the pure elements are initially melted to form a prealloy, in order then to atomise this alloy. In particular Zr and Cr are advantageously atomised as CuCr and CuZr, since thus the high reactivity of the pure elements Cr and Zr can be circumvented. Due to the atomisation process, the desired particle-size distribution and chemical composition can be controlled within narrow tolerances.

Advantageously, chips occurring in the production of cast CuCrZr are used for producing the sintering powder, which as a result can be produced in a cost-efficient and resource-efficient manner.

It is advantageously possible to lower the sintering temperature by the preferred deliberate increase of the fines content, i.e. particles of <5 μm, to at least 5%. This further offers the advantage that the high proportion of fine powder which is for technical reasons can be utilised in the context of the invention without adversely influencing the flow properties.

On casting the CuCrZr alloy, on the other hand, advantageously the process steps for powder production can be dispensed with.

According to a preferred configuration of the invention, at least part of the plain bearing, preferably the CuCrZr alloy, is subjected to heat treatment, preferably solution annealing, hot age-hardening and/or soft annealing, in order to be able to set the structure to correspond to the use requirements.

Preferably, furthermore, at least part of the plain bearing, preferably the CuCrZr alloy, is mechanically processed, in order to obtain for example the necessary surface qualities or component dimensions.

All the features mentioned previously and subsequently in conjunction with the plain bearing may also be applied in the method according to the invention and the novel use, and vice versa.

### PREFERRED EMBODIMENT

According to a preferred embodiment, a plain bearing, consisting of a steel backing and a sinter layer of a CuCrZr alloy applied thereon, is provided. To produce it, initially a sintering powder mixture having the percentages by weight 1.0% by weight Cr and 0.1% by weight Zr, and also copper as remainder is produced. To this end, pure substances of the alloying elements are atomised using an atomisation installation such that a fines fraction <5 μm of 10% by weight results. The sintering powders are mixed, compacted on a steel backing and sintered at a temperature of 950° C.. After the first sintering operation, there follows a roll pass and also a second sintering operation at 950° C., which is again followed by a second roil pass, so that a material with a homogeneous structure and a porosity of less than 0.3 volume percent results.

1. A plain bearing or part thereof comprising a CuCrZr alloy which has a porosity of <0.3 volume percent.

2. The plain bearing or part thereof according to claim 1, wherein the CuCrZr alloy consists of 0.01 to 0.5% by weight Zr, 0.01 to 4.9% by weight Cr, and also copper as remainder and up to 0.5% by weight unavoidable impurities.

3. The plain bearing or part thereof according to claim 2, wherein the CuCrZr alloy additionally contains 0.01 to 15.0% by weight Sn.

4. The plain bearing or pad thereof according to claim 2, wherein the CuCrZr alloy additionally contains Al, Mg, Ti and/or Mn in a concentration range of 0.15 to 0.25% by weight in each case.

5. The plain bearing or part thereof according to claim 2, wherein the CuCrZr alloy has further functional additions such as solid lubricants, preferably h-BN and/or graphite, hard particles, preferably oxides, carbides, nitrides and/or phosphides, chip breakers, preferably tellurium, bismuth, lead and/or sulphur, and/or corrosion inhibitors.

6. The plain bearing or part thereof according to claim 1, wherein the CuCrZr alloy is applied to a substrate backing.

7. A method for producing a plain bearing or a part thereof according to claim 1, which is manufactured at least partially from a CuCrZr alloy, with at least part of the plain bearing, preferably the CuCrZr alloy, being subjected to heat treatment, preferably solution annealing, hot age-hardening and/or soft annealing.

8. The method for producing a plain bearing or a part thereof according to claim 7, wherein functional additions such as solid lubricants, preferably h-BN and/or C, hard particles, preferably oxides, carbides, nitrides and/or phosphides, chip breakers, preferably tellurium, bismuth, lead and/or sulphur, and/or corrosion inhibitors are introduced.

9. The method for producing a plain bearing or a part thereof according to claim 7 wherein the CuCrZr alloy is processed as a solid material.

10. The method for producing a plain bearing or a part thereof according to claim 7 wherein the CuCrZr alloy is applied to a substrate backing.

11. The method for producing a plain bearing or a part thereof according to claim 10, wherein the CuCrZr alloy is applied to the substrate backing by roll bonding cladding, a galvanic process and/or a sputtering process.

12. The method for producing a plain bearing or a part thereof according to claim 7, wherein the CuCrZr alloy is formed by a sintering process, consisting of at least one, preferably two, sintering operations.

13. The method for producing a plain bearing or a part thereof according to claim 12, wherein at least one, preferably each, sintering operation is followed by at least one roll pass.

14. The method for producing a plain bearing or a part thereof according to claim 7, wherein the sintering takes place at temperatures of 950° C. to 1000° C.

15. The method for producing a plain bearing or a part thereof according to claim 8, wherein the functional additions such as solid lubricants, preferably h-BN and/or C, hard particles, preferably oxides, carbides, nitrides and/or phosphides, chip breakers, preferably tellurium, bismuth, lead and/or sulphur, and/or corrosion inhibitors are introduced via a preceding grinding and mixing process.

16. The method for producing a plain bearing or a part thereof according to claim 7, wherein the CuCrZr alloy is a sintering powder produced by an atomisation process, preferably of pure elements and/or the prealloys thereof.

17. The method for producing a plain bearing or a part thereof according to claim 16, wherein the sintered powder is made from chips occurring in the production of cast CuCrZr.

18. The method for producing a plain bearing or a part thereof according to claim 16, wherein the sintering powder has a fines fraction <5 μm of over 5% by weight.

19. The method for producing a plain bearing or a part thereof according to claim 7, wherein the CuCrZr alloy is processed by a casting process.

20. The method for producing a plain bearing or a part thereof according to claim 7, wherein at least part of the plain bearing, preferably the CuCrZr alloy, is mechanically processed.

21. (canceled)

22 The plain bearing or part thereof according to claim 1, wherein said Cr is present in the range of 0.01 to 4.4% by weight.

23. The plain bearing or part thereof according to claim 6, wherein said substrate comprises a steel backing.

24. The method for producing a plain bearing or a portion thereof according to claim 10, wherein the substrate is selected as a steel backing.

25. The method for producing a plain bearing or a portion thereof, according to claim 14, wherein the sintering takes place at a temperature of 950° C. to 980° C.

26. The method for producing a plain bearing or a portion thereof, according to claim 18, wherein the fines fraction is at least 10% by weight.
